(19) United States
(12) Patent Application Publication
(10) Pub. No.: US 2015/0220691 A1
(43) Pub. Date: Aug. 6, 2015

(54) Methods for Creation of Radiology and Clinical Evaluation Reporting Templates Created Using Fuzzy Logic Algorithms Complied Using ICD-10, CPT Code, ACR Appropriateness Criteria® Data Custmized to Document the Specific Criteria of the Medical Payer's Proprietary " Medical Indication" Criteria Using A Secure Private Cloud-based Processing and Synchronization System

(71) Applicant: Douglas K. Smith, San Antonio, TX (US)

(72) Inventor: Douglas K. Smith, San Antonio, TX (US)

(73) Assignee: VIRTUAL VIEWBOX, LLC, San Antonio, TX (US)

(21) Appl. No.: 14/258,938

(22) Filed: Apr. 22, 2014

Related U.S. Application Data
(60) Provisional application No. 61/814,914, filed on Apr. 23, 2013.

(51) Int. Cl. G06F 19/00; G06F 17/24

(52) U.S. Cl. CPC G06F 19/328; G06F 19/322; G06Q 40/08; G06F 17/248

(57) ABSTRACT

The preferred embodiment of the invention generates customized reporting templates in response to actions taken by healthcare payer organizations. The templates are generated in response to the bases of rejection relied upon in previous rejections. As appropriate, responses to specific criteria and references to commonly utilized medical coding are incorporated as necessary into the generated templates.

### CROSS-REFERENCE TO RELATED APPLICATION

This application claims the benefit of U.S. Provisional Application No. 61/814,914, filed Apr. 23, 2013.

### DESCRIPTION

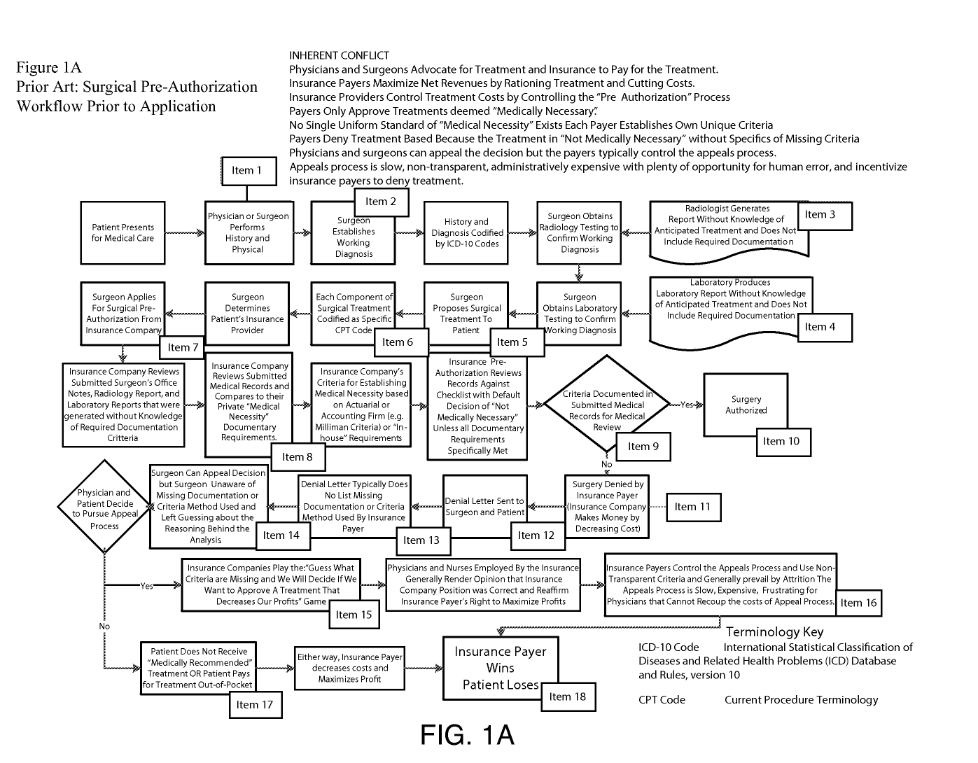

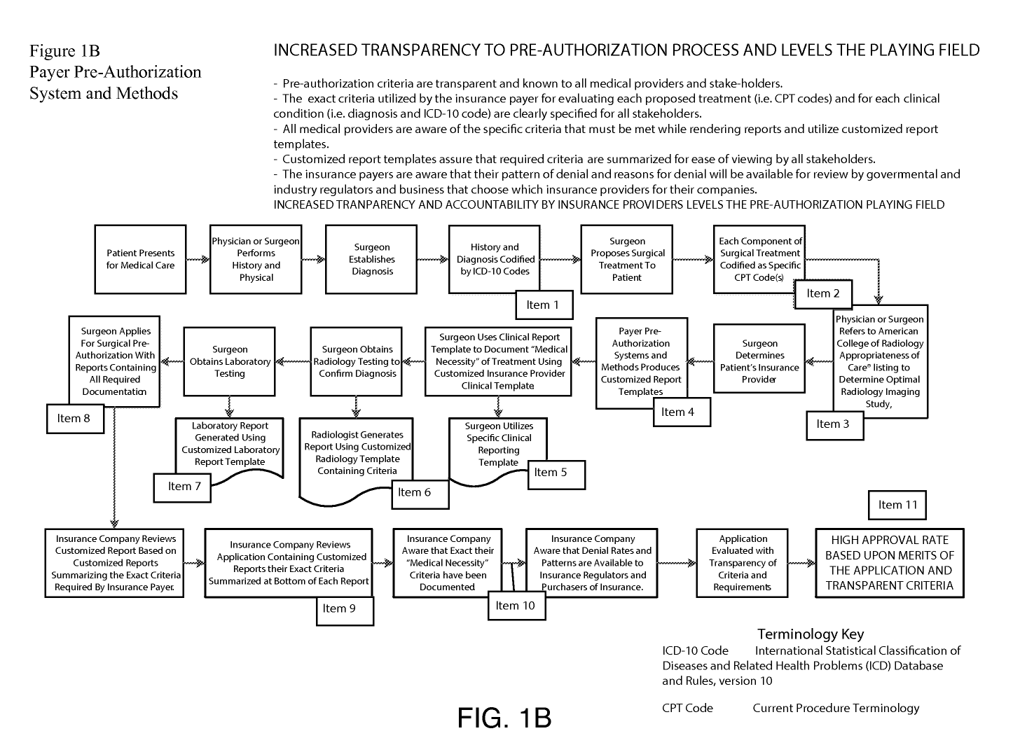

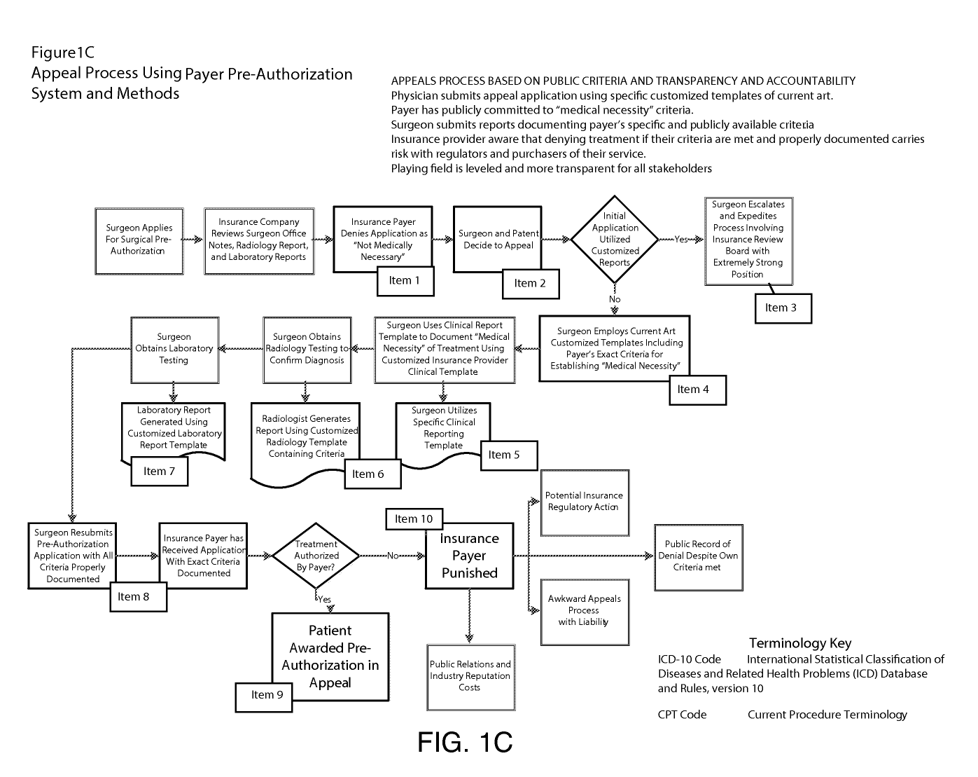

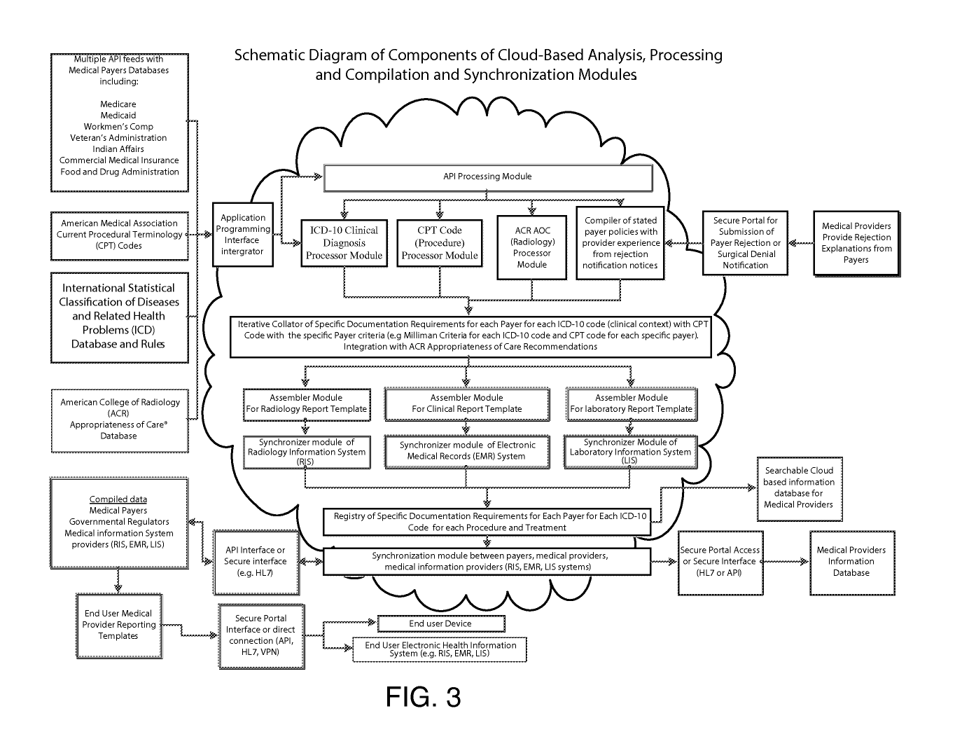

Generally, in this Application, the Applicant provides a payer pre-authorization navigation system and methods of use as generally illustrated in FIG. 1b and FIG. 3 among other Figures in this Application. In this application “payer” refers to the insurance company that provides coverage to a patient that seeks medical care and has presented the need to at least one physician for diagnosis. The payer pre-authorization navigation system, in part, develops a series of customized report templates based on a reference code created by the payer pre-authorization navigation system. In one aspect, among others, the customized report templates are provided to computer-based Information Systems of a type will known in the Healthcare industry a Radiological Information System (RIS) and a Hospital Information System (HIS), among others. The reference code is created, at least in part, from a combination of CPT and ICD-10 codes by the payer pre-authorization navigation system. Illustratively, as a physician establishes a diagnosis for a specific patient case the payer pre-authorization navigation system fetches corresponding CPT and ICD 10 codes specific to the patient case to thereby create a reference code based on the fetched CPT and ICD 10 codes. In one aspect, the payer pre-authorization navigation system is communicatively coupled to and interfaces with the Healthcare Information Systems to obtain, in part, data input regarding patent medical case-specific payer criteria. In one aspect, the payer pre-authorization continuously updates the payer criteria and reference code in real-time. The payer pre-authorization navigation system matches the derived reference code with the corresponding payer's criteria to create a self-updating customized report template. The customized report template is applied to the computer-based Information System in the Healthcare industry to permit the Information System to provide an interface that acts as an updated, interactive guide or “check-list” for the diagnosing physician in documenting the patient's condition BEFORE pre-authorization to assure payer's criteria are met.

Moreover, in addition, the payer pre-authorization navigation system provides at least one a method to guide a diagnosing physician in the insurance or “payer” appeals process via the interactive templates supplied to the Healthcare information System so as to interface with the payer pre-authorization navigation system. For example, if a diagnosing physician fails to use the payer pre-authorization navigation system before payer pre-authorization the system provides at least one appeals process guide applicable to the specific patient's case.

In one further aspect, the payer pre-authorization navigation system derives a searchable cloud-based database of insurance providers or, commonly termed in the industry, “payer” pre-authorization rejection documentation data. In one aspect, the payer pre-authorization navigation system facilitates greater transparency by collectively identifying and processing the reasons that are behind each insurance company (i.e. “payer) pre-authorization rejection letter. From the “bits and pieces” of searchable reasons for rejection the payer pre-authorization navigation system collectively creates a database for the reasons why a particular insurance company rejects pre-authorization for a corresponding diagnosis. The payer pre-authorization navigation system accesses the pre-authorization rejection documentation data each time a customized report template is generated for a specific diagnosis before preauthorization. In one aspect, if the specific payer falls outside the normal range, an analysis is performed by the payer pre-authorization navigation system to determine if there are specific triggers or characteristics of previous pre-authorization rejections and the results considered for modification of the templates. In at least one further aspect, the payer-preauthorization system provides the derived, searchable, cloud-based database to subscribers as a cloud based service, such subscribers include, among others, insurance regulators and any purchasers of insurance.

The accompanying figures, where like reference numerals refer to identical or functionally similar elements throughout the separate views, together with the detailed description below, are incorporated in and form part of the specification and serve to further illustrate various embodiments of concepts that include at least one embodiment of the present invention, and to explain various principles and advantages of those embodiments.

Presently, there is clinical crisis in medicine surrounding the approval process for medical and surgical procedures. Historically, physicians determined what was “medically indicated” for the treatment of their patient's medical condition and were compensated for their services by the patient's insurance company or payer if the procedure was included in the covered procedures by patient's insurance or payer. During the past decade, the authority for medical decision making has transferred from physicians and medical providers to insurance companies that determine whether they will pay for the treatment.

Financial stresses to the Federal Medicare and Medicaid systems have produced statues that authorize payment only for those treatments that are deemed “medically necessary” and impose criminal and civil liability for filing claims that are “medically unnecessary.” The Office of Inspector General at the Department of Health and Human Services (DHHS) in its draft compliance program for “Individual and Small Group Physician Practices” states that “Medicare (and many insurance plans) may deny payment for a service that the physician believes is “clinically appropriate”, but which is “not reasonable and necessary.” The line and documentary requirements between “clinically appropriate” and “medically necessary” care is left to the insurance payers that have an obvious conflict of interest because the insurance company's profits are maximized by denying surgery that is “medically recommended” but does not meet an the insurance company's requirements to meet their standard of “medical necessity”.

Providers and consumers are left uncertain about whether their insurance company will authorize a medical treatment that has been recommended by their doctor and ultimately whether the insurance company will pay for the treatment after treatment has been rendered.

Generally, the insurance payer is the sole determiner of whether a proposed procedure is “medically necessary” and whether the insurance company will pay for the procedure or treatment. This creates an inherent conflict of interest because “medical necessity” of a surgical procedure is in the “eye of the beholder” and is solely determined by employees (or paid consultants) of the insurance company with an obvious conflict of interest. The costs of the insurance payer are decreased (and profits maximized) if the proposed treatment or surgery is not performed because the treatment is deemed “not medically necessary”. The profits of the insurance company are diminished by paying for “medically recommended” but “not medical necessary” treatment. It is obvious that the insurance company makes more profits if authorization for payment is denied because the proposed treatment is deemed “not medically necessary”.

In order to defend against criticism from medical providers and patients, some insurance companies have employed consulting actuaries and accounting firms to develop “proprietary” documentary criteria for establishing that a treatment is “medically necessary”. Some critics argue that actuaries are evaluating the cost effectiveness of stringency of “medical necessity” requirements (i.e. profitability) of a criteria compared to the indirect public relations cost (decreased sales of their insurance and relative attraction of their insurance product compared to competition in the industry). In general, critics argue that the “criteria” are not uniform and the evaluation process is not transparent.

The insurance company's “criteria” must be documented in the medical record, radiology report and/or laboratory reports in order for the payer to consider the proposed treatment “medical necessary” and for the insurance company to authorize payment for the medical treatment or surgery. From a medical provider's perspective, payers use a default decision of “denial” unless the medical records specifically document all of the insurance company's unique criteria. Many medical providers complain that there is far greater variability between insurance companies' documentation criteria standards than there is variability in the medical standard of care for most treatments.

The insurance company may not publicize the criteria or the insurance company's documentation requirements and medical providers are left guessing what documentation was missing when they receive a pre-authorization denial notification from the insurance company stating that the proposed treatment was denied because the proposed treatment was deemed “Not Medically Necessary”. In some cases medical payers have pre-authorized a surgical procedure only to deny payment for the surgical procedure after the surgical procedure has been performed (AKA retroactive denial) and after costs have already been accrued by the hospital and treating physician. In many cases, the justification for the payment denial is that the medical records did not specifically and completely document the payer's unique standards for determining “medical necessity”.

There are no known standardized criteria for determining “medical necessity” in the medical industry. Each payer often uses their own unique criteria and applies them in their own unique fashion. There also exists an obvious conflict of interest because the profits of the insurance payer are maximized by denying treatment and thereby reducing costs and the insurance company is the sole determinant of “medical necessity”. This situation sets up a classic “guess what I am thinking” scenario where the medical providers are tasked with providing the exact documentation that an insurance requires although many insurance companies do not publish their requirements and have significant financial incentives to deny treatment and ration care and thereby maximize profits and satisfy insurance company investors,

As a physician is evaluating a patient for a specific surgical treatment of a specific medical condition, it would be a tremendous advantage for all physicians to use specifically designed medical reporting templates specifically designed to meet the documentary “criteria” for their patient's specific insurance payer. Each customized template would be specific to each clinical scenario (i.e. ICD-10 code) and proposed procedure or treatment (CPT code(s)) combination whereby such combination of ICD-10 codes and CPT codes in this disclosure at least in part defines a “reference code” created by the of which the Applicant's system, i.e a payer pre-authorization navigation system. There exists a need for a system that provides computer-based templates to prompt medical providers to provide the specific medical record documentation that the specific medical payer requires to establish “medical necessity” of the surgical or medical procedure being considered. The payer pre-authorization navigation system would create reports that provide the documentation that the insurances provider requires in the exact form and content required to establish the criteria. Templates and reports are provided to any electronic medical record (EMR) system. In addition, if radiologists had access to a customized reporting template (e.g. within an electronic medical record (EMR) or radiology information system (RIS) or picture archive and communication system (PACS), the specific criteria within the report template would assist the radiologist in providing the required documentation in order to meet the payer's definition of medical necessity and assure payment by the payer.

A customized report template for diagnostic testing laboratories would also be helpful for laboratory reporting and could be utilized with the lab's laboratory information system (LIS).

If the insurance payer denies pre-authorization, a physician and patient can appeal the insurance company's decision but the appeals process is very expensive, tedious, and the insurance company is both the judge and jury. Many insurance providers will not disclose their criterion system or disclose the missing criteria or medical records that could be used to complete the checklist to meet their standard of “medical necessity”. In addition, the insurance payer has a direct financial disincentive for denying the appeal. If the physician facing an appeals process were equipped with specific clinical and radiology report templates that include the specific criteria required to meet the “medical necessity” definition of the specific payer, the physician would be equipped with the requisite information to formulate a compelling appeal of the treatment authorization process.

As a byproduct, the process would document the practices of medical (insurance) payers of approving and disapproving medical treatments. This information would be valuable to insurance regulators and large purchasers of medical insurance and medical care and could be a powerful method for providing transparency in the medical insurance industry.

FIG. 1, in general, is a system diagram illustrating one aspect of a customized radiology and clinical evaluation report template generation system of a payer pre-authorization navigation system in accordance with embodiments of the present disclosure. (FIG. 1B contains specific item numbers identifying the component items of the payer pre-authorization navigation system). The payer pre-authorization navigation system includes a cloud-based system designed to assure that the specific clinical medical records and radiology reports include the specific documentation requirements to meet the specific proprietary “Medically Necessary” criteria are utilized by the patient's medical payer or insurance company for a specific clinical condition and specific American Medical Association's Current Procedural Terminology (CPT) of surgical procedures being considered. In one exemplary embodiment, the payer pre-authorization navigation system is a secure, private cloud-based, application that is comprised of a series of modules designed to accept specific requirements from a variety medical payers using a variety of secure data exchange methods (including for example Application Programming Interface (API), Virtual Private Network (VPN), or HL7 Integration Engine (item 1). The payer pre-authorization navigation system integrates with the American Medical Association's CPT Code registry using any of variety of constant data input methods (e.g. API, VPN, HL7) demonstrated in item 2). The term “cloud computing” in this application and appended drawings refers to computing models for enabling network access to a shared pool of configurable computing resources, such as among others networks, servers, storage, applications, and services. The terms “cloud-based”, “cloud computing”, “cloud” in this application and appended claims refers to computing models for enabling network access to a shared pool of configurable computing resources, such as among others networks, servers, storage, applications, and services.

a. The payer pre-authorization navigation system accepts data feed from the International Statistical Classification of Diseases and Related Health Problems (ICD) Database and Rules: version 10 (ICD-10) using any of variety of constant data input methods (e.g. API, VPN, HL7) demonstrated in item 3. The payer pre-authorization navigation system accepts data feed from the American College of Radiology (ACR) Appropriateness of Care® Database using any of variety of constant data input methods (e.g. API, VPN, HL7) demonstrated in item 4.
b. The data feeds from multiplicity of data feeds, including but not limited to those listed above, are managed by a series of APIs (of a type(s) well known in the industry). An API processing module (item 6) accepts the data feeds from multiple medical coding and criteria databases and disseminates the pertinent data to the appropriate processing modules for International Statistical Classification of Diseases and Related Health Problems (ICD) Database and Rules: version 10 (ICD-10), Current Procedural Terminology (CPT), and American College of Radiologist Appropriateness of Care® processor modules. The payer pre-authorization navigation system also accepts authorization denial notifications from medical practitioners using a variety of data input methods through a secure cloud portal interface. The payer pre-authorization navigation system accepts data from a multitude of Proprietary “Medical Indication” Criteria used by Medical Payers using API, HL7, or VPN.

### WITH REFERENCE TO THE FIGURES

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### BRIEF DESCRIPTION OF THE FIGURES

FIG. 1 is an overview of the typical surgical pre-authorization work, system, methods, and appeals process that is status quo, before implementation of the current invention.

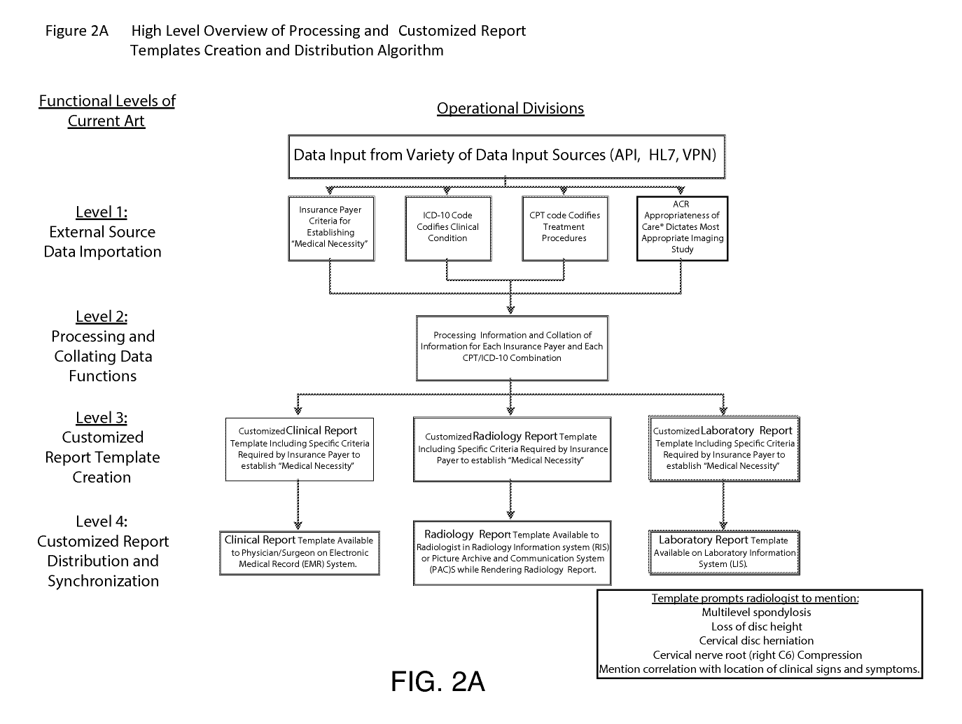

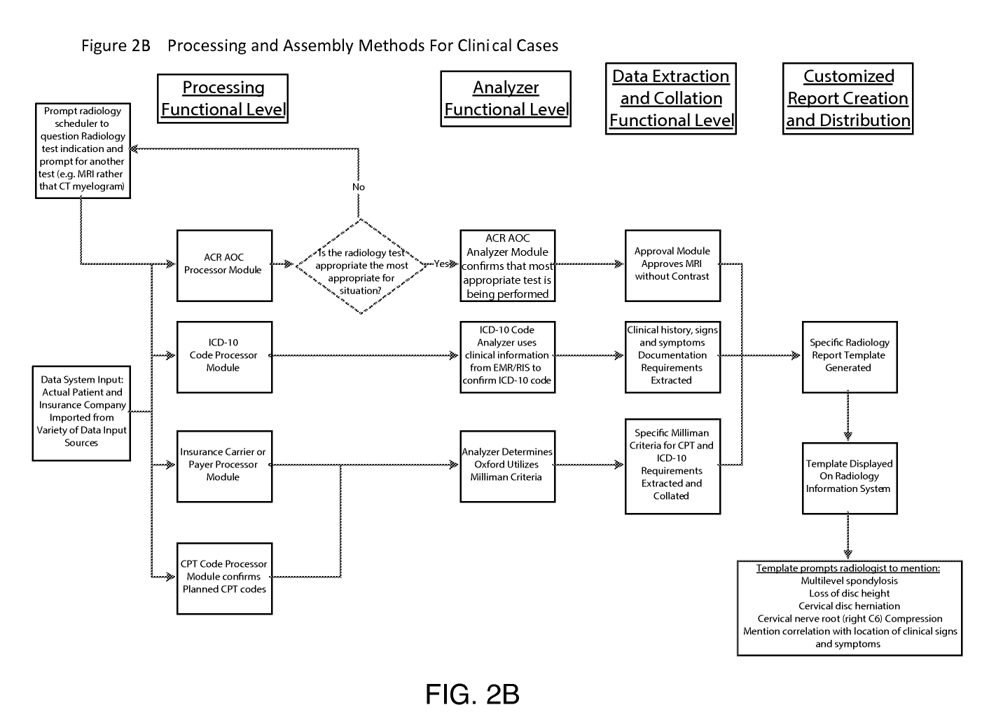

FIG. 2 is an overview of the algorithm that is used to create and distribute processing and report templates for clinical cases.

FIG. 3 is a schematic diagram of embodiment components for cloud-based modules of analysis, processing, compilation, and synchronization.

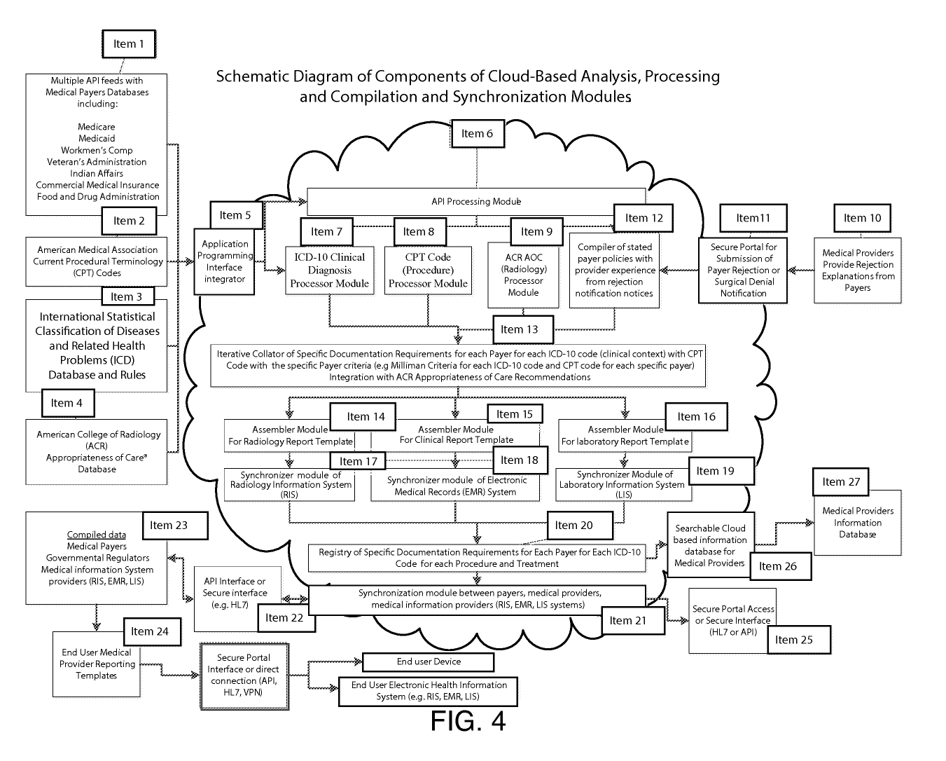

FIG. 4 is FIG. 3 with added item labels.

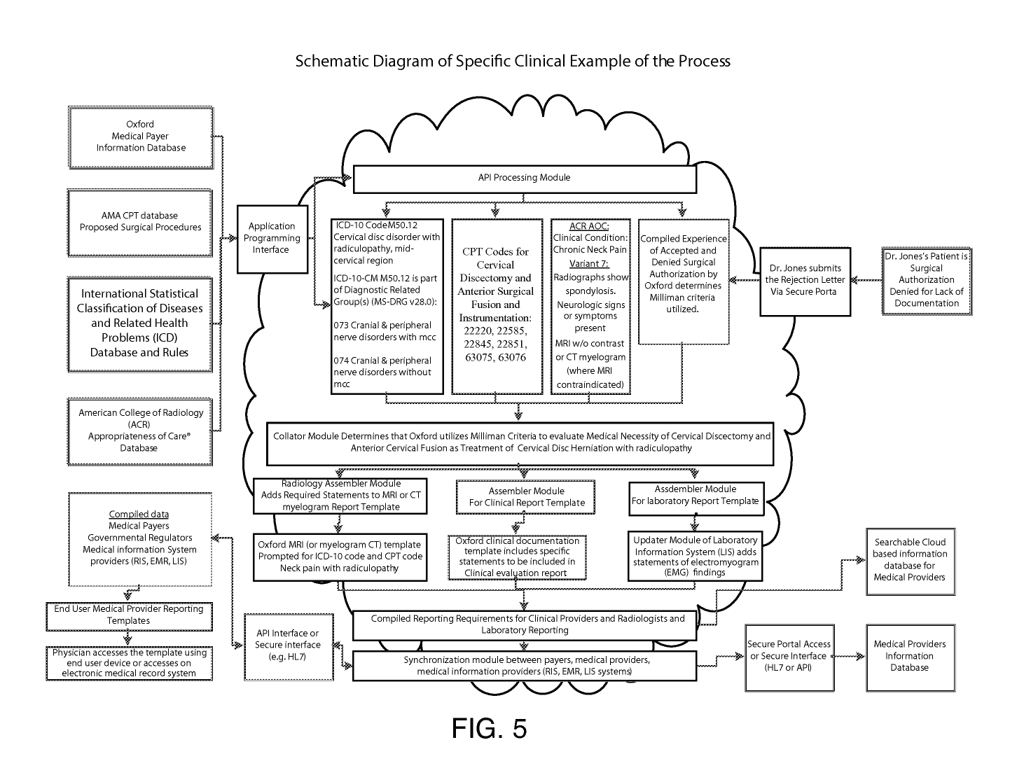

FIG. 5 is a schematic diagram of an expected example use of the embodiment process.

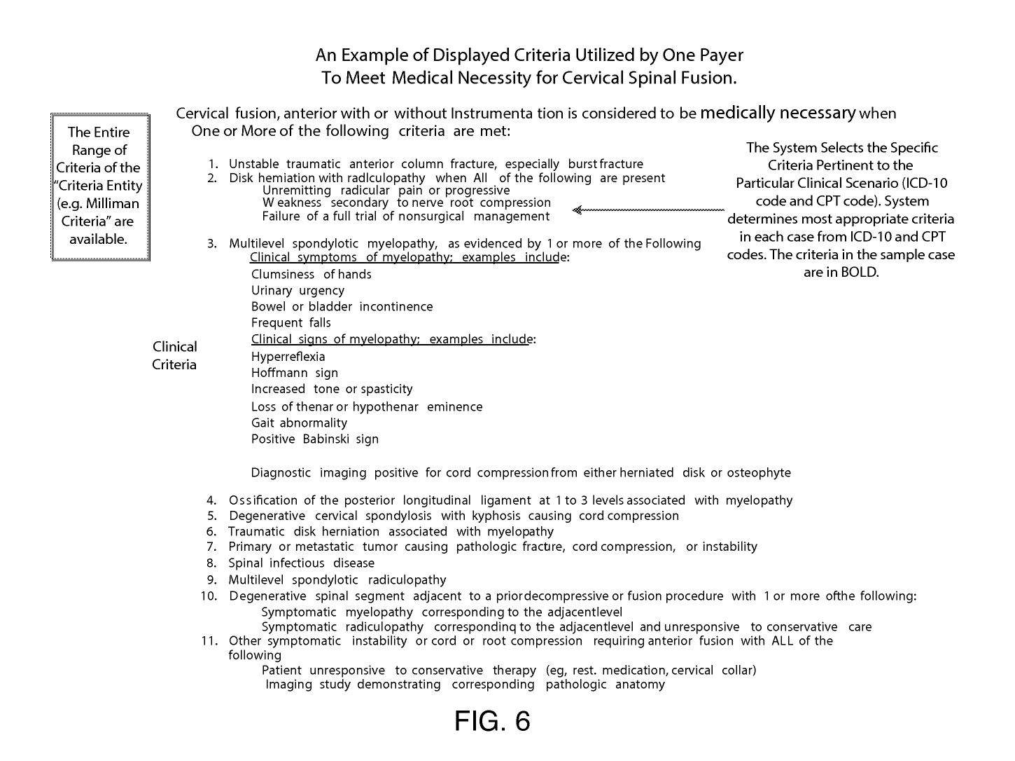

FIG. 6 is example clinical criteria that one payer might use to determine “medical necessity.”

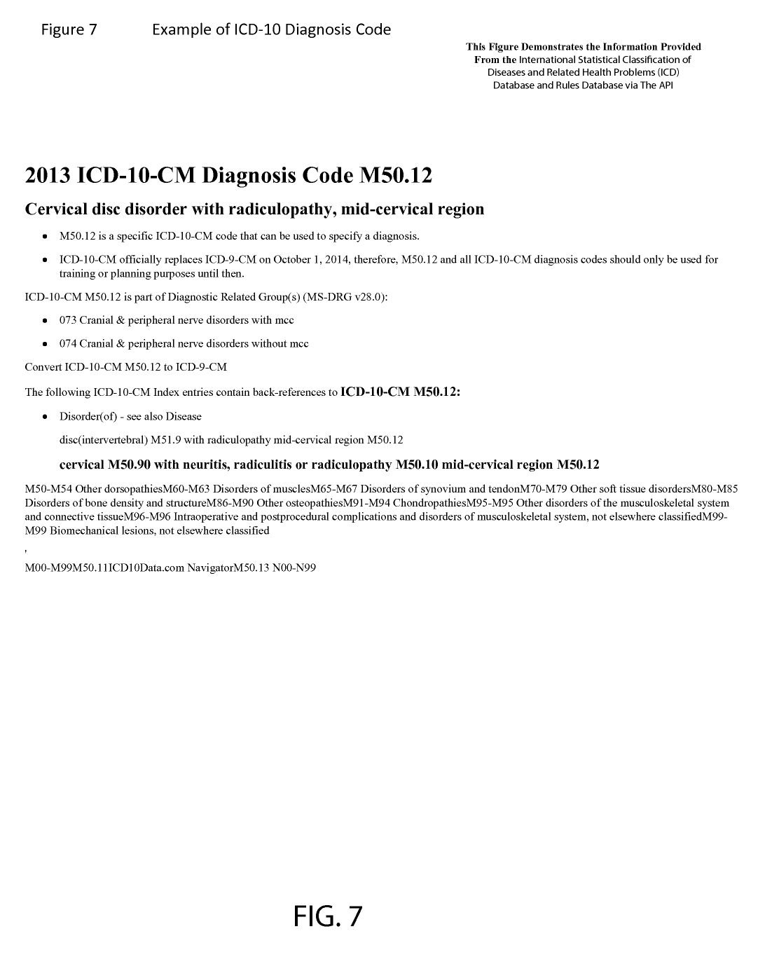

FIG. 7 is an example of an ICD-10 Diagnosis Code

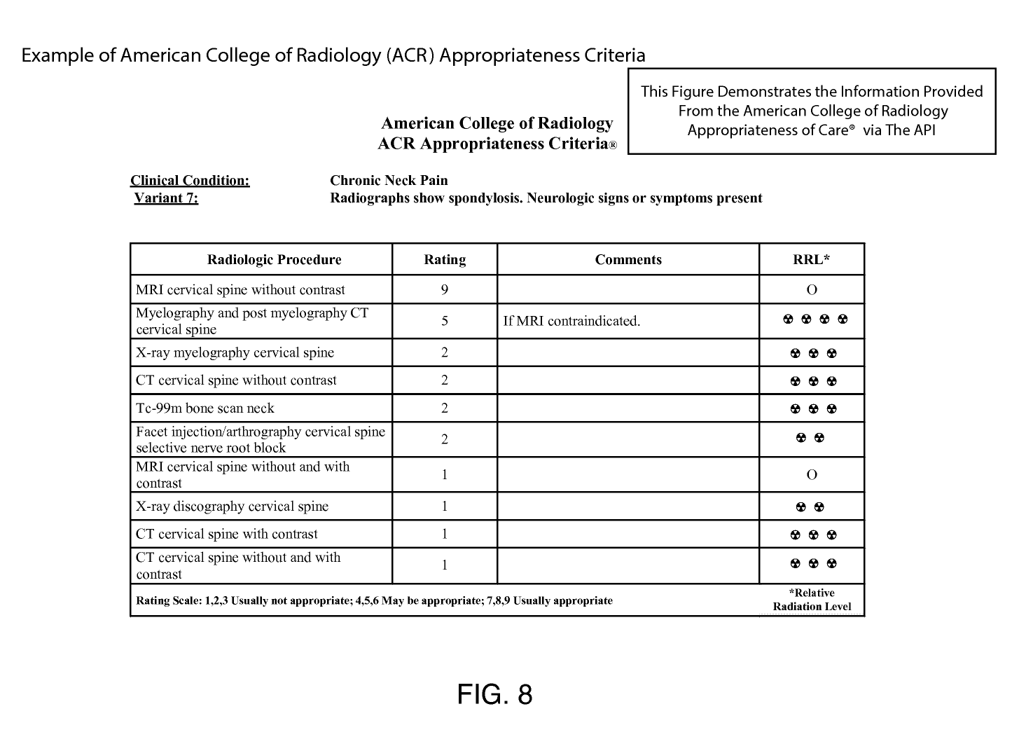

FIG. 8 is an example of Appropriateness Criteria from the American College of Radiology

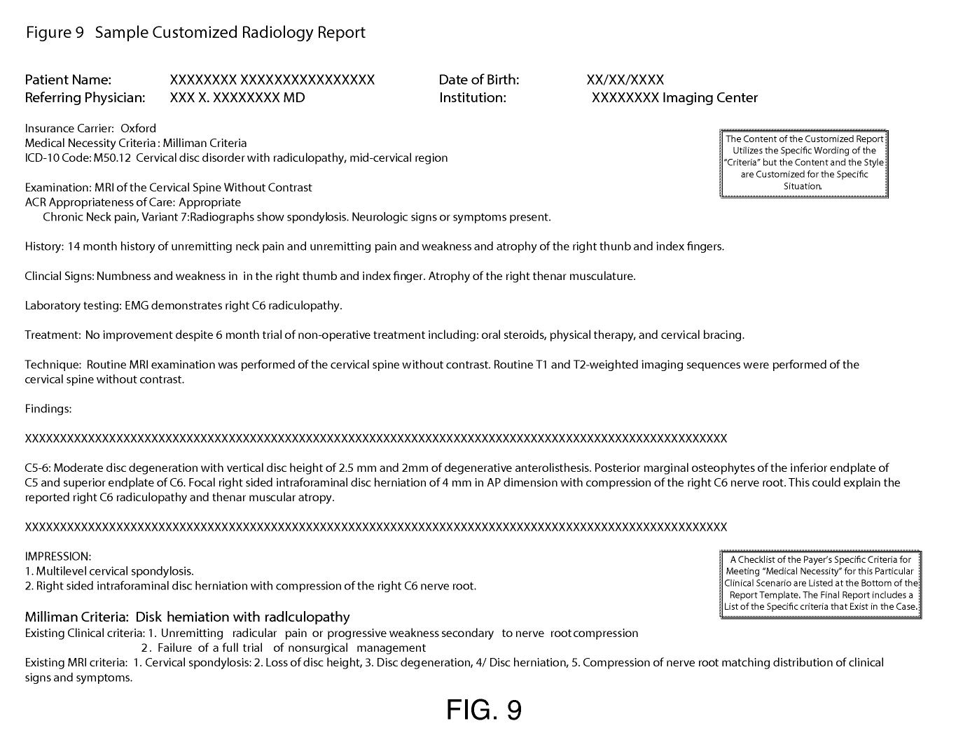

FIG. 9 is a sample of an embodiment of a Customized Radiology Report

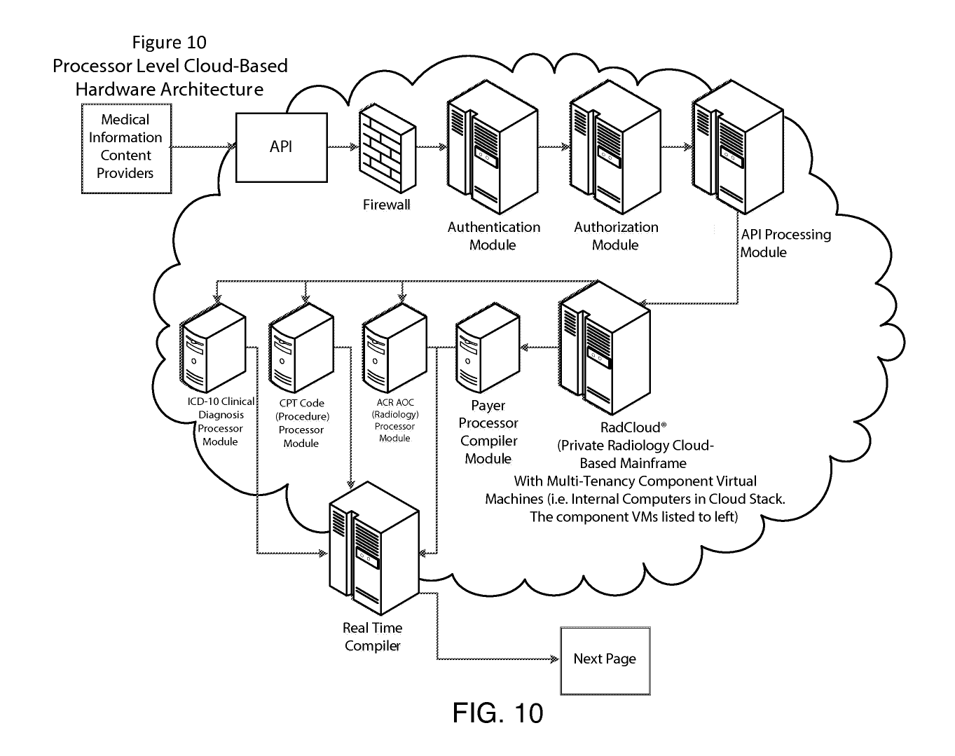

FIG. 10 is the cloud-based hardware architecture for the processing of data

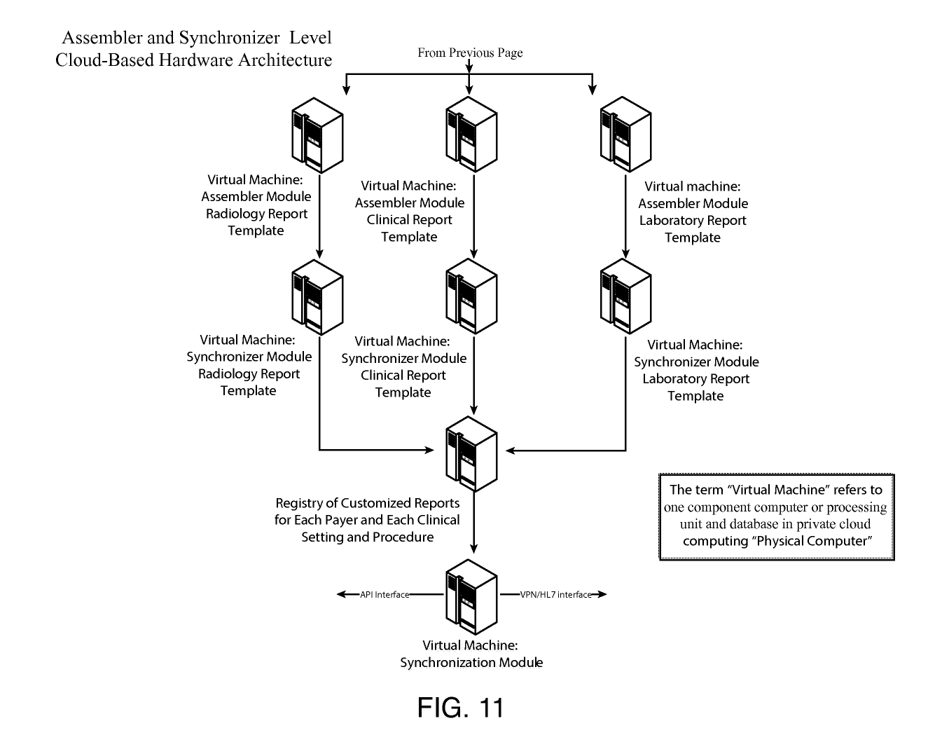

FIG. 11 is the cloud-based hardware architecture at the assembler and synchronizer level

### DETAILED DESCRIPTION OF THE FIGURES

FIG. 1: FIG. 1, including FIGS. 1a-1c, generally are each schematic, high level process diagrams displaying typical medical evaluation and treatment workflows. Specifically, a process diagram of typical prior art practice (shown in FIG. 1a) and a process diagram of how the payer pre-authorization navigation system would significantly change the application and approval process for payment pre-authorization by insurance payers applying the tools described in this application (proposed art in FIG. 1b.) If a physician and patient receive a pre-authorization denial from an insurance provider using “current art” workflow, the physician could employ the tools described in this application to resubmit an application including, among others, the customized reporting templates or gain substantial advantage in the appeals process using proposed art described in this application.

FIG. 1a shows the typical practice designed to meet the “medically indicated” standard of care. The physician or surgeon performs a history and physical (refer to “Item 1” in FIG. 1a) and develops a “working diagnosis” (Item 2) and may discuss treatment options with the patient. The physician orders confirmatory radiology imaging (Item 3) and laboratory studies (Item 4) although the interpreting radiologist and laboratory are rarely aware of the proposed surgical treatment or the specific documentary requirements of their reports required that are required by patient's insurance company to meet the standard of “medical necessity” for the treatment later considered by the treating physician or surgeon. As a result the reports may be accurate by may not include the specific wording or criteria that the insurance company reviewer will be looking for later to determine “medical necessity”. The physician or surgeon proposes a treatment to the patient (Item 5) and determines the CPT codes that describe the medical treatments or surgery being proposed (Item 6). The physician submits a pre-authorization application to the patient's medical insurance company (Item 7) including the medical records and radiology and laboratory reports that were generated without knowledge of the proposed treatment or the specific documentary requirements required by the patient's insurance payer. The “pre-authorization” evaluator for the insurance company analyzes the submitted medical records searching for the specific items that meet the insurance company's documentary requirements to complete the insurance company's “medical necessity” checklist (Item 8).

If the insurance company's evaluator determines that all the checklist requirements are met, the pre-authorization is approved (Item 10). If one or more criteria are not documented in the required form or fashion OR if the evaluator cannot easily locate the required documentation, the pre-authorization is denied (Item 11) and the doctor and patient are sent a pre-authorization “denial” letter. The insurance payer “denial letter” frequently does not disclose the specific evaluation criteria or the additional criteria that would be required to complete documentation of the insurance carrier's criteria of “medical necessity (Item 13). The physician or surgeon learns that pre-authorization has been denied but does not know what criteria were missing or what specific documentation is required to reverse the insurance company's decision (Item 14).

The physician and patient have an important decision in that they can appeal the insurance company's decision although the appeals process is usually tedious, expensive, and the insurance company controls the appeals process and often serves as both the judge and jury during the appeals. The insurance company employs medical providers that testify why the proposed treatment may “medically recommended” or even “efficacious” although the proposed treatment does not meet the insurance company's requirements to establish “medical necessity”. Frequently, the insurance company plays the game of “guess what we need” (Item 15) with the physician trying to meet an endless list of requirements and ultimately giving up because the physician is not compensated for appeals process and cannot afford to continue the process (Item 16). If the physician and patient decide not to pursue the appeals process, there are only two options: the patient does not receive the “medically recommended” treatment OR the patient pays for the procedure out-of-pocket (Item 17). Either way, the insurance company wins (eliminates costs and maximizes profits), and the patient loses by not obtaining the recommended treatment (Item 18).

FIG. 1b displays how one embodiment of the present invention that dramatically changes the medical and surgical pre-authorization process and introduce transparency and accountability into the process and thereby creating a more level playing field. All medical providers evaluate the patient and generate customized report templates created by the application that include the specific documentary requirements of the patient's insurance payer's for the medical condition and the proposed treatment. The entire process is designed with the ultimate goal of providing documentation to meet the “medical necessity” documentation requirements.

The physician or surgeon performs a history and physical exam and establishes a diagnosis (codified using ICD-10 codes (Item 1)) and establishes a treatment plan (codified by CPT codes (Item 2)). The physician refers to the American College of Radiology's Appropriateness of Care® to assure that most appropriate radiology testing is performed to evaluate the patient's condition (Item 3). The application processes the combination of ICD-10 code(s), CPT code(s), the ACR AOC recommendations and compiles customized medical record (Item5), radiology (Item 6) and laboratory report (Item 7) templates designed to document the insurance company's specific requirements to establish “medical necessity” of the proposed procedure(s). When the surgeon applies for pre-authorization of the treatment, he submits reports including documentation of each of the insurance company's specific requirements to meet their specific “medical necessity” criteria (Item 8). In one aspect of the invention, each of the insurance company's documentary requirements are listed at the bottom of the respective report making it very easy for the reviewer to locate the required documentation (Item 9). In one aspect of the invention, the insurance company reviews pre-authorization applications with the knowledge that their exact documentary requirements are fulfilled and that the current art records the insurance company's record of pre-authorization denial and that this information may become available to industry regulators and potential large companies considering purchasing their health insurance (Item 10). The transparency of this process and the ultimate accountability for a pre-authorization “denial” levels the playing field and empowers the physician and his patient. Accordingly, this produces a higher approval rate based upon the merits of the application using transparent evaluation criteria (Item 11).

FIG. 1c FIG. 1c illustrates that if the insurance company denies the pre-authorization application of FIG. 1b based on failure to meet the “medical necessity”, then documentation requirements (Item1)., the physician and patient are in a much stronger position to mount an appeal of the insurance company's denial decision (Item 2). If the surgeon utilized the current art to submit reports that document the specific requirements, the surgeon can choose a higher regulatory authority and have a very strong case for appeal (Item 3). If the surgeon did not use the Applicant's system (i.e. the payer pre-authorization navigation system) and the report templates when preparing the documentation for the pre-authorization application, the surgeon can utilize the customized clinical (Item 5), radiology (Item 6), or laboratory (Item 7) report templates of the current art to document the insurance company's specific criteria and reapply or appeal the original decision (Item 8). If the insurance company approves the pre-authorization application, the patient and surgeon win. If the insurance company still denies the pre-authorization application with their exact criteria, they do so at great peril: legal, regulatory and public relations. In addition, the insurance company's record of pre-authorization denial would be available to government regulators and potential purchasers of the insurance company's services. The transparency of the evaluation process and the accountability of the insurance company for approval and denial of decisions creates a more level and playing field and empower the patient and the physician in the process.

FIG. 2: High Level Schematic Diagram of the Functional and Operational Segments of the Current Art.

FIG. 2a is a schematic representation of the functional and operational divisions and processes of the Applicant's payer pre-authorization navigation system. This figure demonstrates the operational steps required to create customized report templates from the disparate data inputs into the payer pre-authorization navigation system. In functional Level 1 of FIG. 2a, data is imported from multiple sources for pertinent data. In functional Level 2, the imported data is extracted from the multiple data sources, processed and collated into a database containing information about the criteria for each insurance payer for each clinical condition and procedure combination. In functional Level 3 of FIG. 2a, customized report templates are created for clinical report, radiology report, and laboratory report that incorporate the specific documentation requirements for the corresponding insurance payer in the exact clinical setting (ICD-10 code) and procedure (CPT code) combination. These templates will prompt the user to mention specific items in the report and list the documentary requirements as a dynamic checklist at the bottom of each report. In Level 4, the customized report templates are distributed to a variety of databases including the electronic medical record (EMR), radiology information system (RIS), health information systems, and laboratory information system (LIS). When changes are made to any template, this functional Level 4 also synchronizes with the external databases to assure that medical providers are working with the most current version of the customized templates.

FIG. 2b is a schematic diagrammatic representation of the processing, creation and synchronization functions of the Applicant's payer pre-authorization navigation system as the system relates to the processing of information for a particular patient. Data is imported from a variety of data sources including more generalized information about the most appropriate radiology testing from the American College of Radiology Appropriateness of Care®. If the ordered radiology study is not the most appropriate study, a payer pre-authorization navigation system administrator is notified so that the most appropriate radiology test must be obtained. If an inappropriate test is obtained, there is a risk that the insurance payer will deny the pre-authorization application for this reason. The data from multiple data input feeds is initially processed to extract the clinical scenario (ICD-10 code), the planned treatment (CPT code) and the insurance payer identity and the insurance payer's evaluation criteria. The analyzer segment of the Applicant's payer pre-authorization navigation system confirms that the most appropriate radiology imaging study has been obtained, analyzes data from EMR/RIS systems to confirm that the appropriate ICD-10 coding was utilized and is supported by medical records and confirms the criteria that the insurance company utilizes to evaluate pre-authorization applications. The extraction and collation modules approve the planned MRI as the most appropriate radiology testing; extract, confirm, and collate clinical information about the patient that will later be included in the reports as clinical history and pertinent clinical history that will be incorporated in the reports.

The customized report creation, distribution, and synchronization section creates the customized reports for the specific patient by populating the customized report template with the clinical information for the specific patient requesting payer pre-authorization. This clinical information is used to populate the required clinical information criteria in the respective reports. These include history of injury, surgical history, or distribution of pain or numbness in order to determine the distribution of nerve dysfunction (i.e. radiculopathy). The distribution function assures that the customized template for the patient is distributed to electronic medical record (EMR) and radiology information system (RIS) and laboratory information system (LIS). The synchronization function assures that changes in the clinical information or requirements are transmitted to the electronic medical record systems.

FIGS. 3&4 Generally show schematic representations of the processes involved in the application. FIG. 3 does not include item numbers whereas FIG. 4, based on FIG. 3, includes the addition of item numbers.

FIG. 3 Schematic diagrammatic representation of the processes involved in the application without item numbers. Please see the Applicant's description in FIG. 4 below.

FIG. 4 Schematic diagrammatic representation of the processes involved in the application including item numbers.

Item 1 Multiple application programming interface (API) data feeds (or other similar secure data connection interface) connect the application to numerous medical payers databases including: Medicare, Medicaid, Workmen's Comp, Veteran's Administration Indian Affairs, Commercial Medical Insurance, Food and Drug Administration, as well as other payer organizations. These data input feeds provide real-time updates from medical payers regarding policies and criteria used by each payer to assess medical necessity of treatment.

Item 2 The Current Procedure Terminology (CPT) codes represent numerical representations or surgical medical procedures. The CPT codes are revised and updated periodically although unless there is an automated method for assuring that the CPT changes are updated in the application, the incorrect CPT code would be used with resulting declined insurance authorization and even fines and penalties for use of the inappropriate CPT code. An application processing interface (API) connection (or other real-time data feed) updates the application with the latest CPT code information.

Item 3 The current standard is ICD-9 although there is a major new version ICD-10 that will dramatically change the system by adding greater granularity or detail when compared to ICD-9. The mandatory date for implementation is October 2014. A real-time connection with the ICD database would provide any changes or updates in the ICD standards.

Item 4 The American College of Radiology has established a standardized Appropriateness of Care® database that suggests the most appropriate imaging testing to evaluate particular clinical medical conditions. Insurance payers utilize the Appropriateness of Care® to determine whether to pay for imaging studies and whether the results of imaging studies used to justify medical necessity of the proposed treatment (CPT code). An application programming interface (API) (or similar real-time data exchange method) connects the application to the Appropriateness of Care® database to assure the latest of updates.

Item 5 The application programming interface (API) integrator is a hardware and software device that receives and collates streaming data feeds from multiple contributing database feeds and distributes the data feeds to the API processing module.

Item 6 The API processing module is a hardware and software device that receives the data from multiple API connections and distributes the content to the appropriate specific processing module.

Item 7 The ICD-10 (clinical) processing module is comprised of computer hardware and software that processes the data related to clinical information and criteria from the API data feeds and gathers them into categories appropriate for matching, sorting, selecting, and compiling.

Item 8 The CPT (procedure) processing module is comprised of computer hardware and software that processes the data related to procedural information from the API data feeds and gathers them into categories appropriate for compiling.

Item 9 The ACR Appropriateness of Care® processing module is comprised of computer hardware and software that processes the data related to appropriateness of various imaging studies for evaluating the clinical conditions from the API data feeds and gathers them into categories appropriate for compiling.

Item 10 Medical providers provide notifications of rejected authorization for treatment or surgery for processing for potential appeal along with the clinical documentation that was provided to the payer with the pre-authorization request.

Item 11 The secure physician portal provides the hardware and software interface for physician interface to submit rejection notification information from payers and the documentation and includes a Health Insurance Portability and Accountability Act of 1996 (HIPAA) compliant interface that allows the physician to access the cloud-based application in order to submit the appropriate information.

Item 12 The “complier of stated payer policy and with provider experience from rejection notification notices” is comprised of computer hardware and software that processes the information extracted from payer rejection letters submitted by physicians. The compiler extracts the payer identity, the clinical condition being considered, the procedure that was denied, the criteria used to deny the procedure, the source of the criteria used (e.g. Milliman criteria), and the clinical information that was available and missing from the application for the procedure.

Item 13 The “Iterative collator of the specific documentation requirements for each payer” is a computer running software that collates the data from each of the data feeds from each of the processor modules and from the “collator of stated payer policy and with provider experience from rejection notification notices”. This iterative collator is designed to extract the exact criteria (clinical, imaging and laboratory) required to establish “medical necessity” for each of the medical payers the each of the medical condition/CPT codes. The iterative collator also considers the ACR Appropriateness of Care® to assure that standards are developed for each of the radiology tests that might be utilized to evaluate the clinical condition/CPT code to assure that standards of all “appropriate” radiology studies are considered. This iterative collator considers the additional data about a payer's standards obtained from the “rejection letter collator” in order to assure that the collated information represents both the stated policies and the clinical experience of how the policies are implemented in real life.

Item 14 The “Assembler module for radiology report template” assembles a specific radiology report template for each of the clinical condition/CPT code combinations for each of the payers. In one aspect, the Applicant's payer pre-authorization navigation system creates a reference code based, at least in part, on the combination of CPT and ICD-10 codes. The template prompts the radiologist to address the specific clinical and radiologic documentary requirements for specific clinical condition/CPT code for the patient's specific payer. The assembler adjusts the radiology report temple whenever there are changes in the payer's requirements or the experience of physician's experience with rejection letters. The report template will include a checklist each of the requirements at the bottom of the report so that all of the payer's requirements are specifically and prominently displayed.

Item 15 The “Assembler Module For Clinical Report Template” assembles a specific clinical reporting template to be delivered to the physician's electronic medical record (EMR) system where it can be populated with the specific clinical information required to document the payer's documentary criteria. The template will include a criteria checklist prominently placed in the template.

Item 16 The “Assembler Module for Laboratory Report Template” assembles a template including a checklist of the specific laboratory documentary criteria for the specific payer requirements.

Item 17 The “Synchronizer module of Radiology Information System (RIS)” updates the RIS of subscriber radiology groups with the customized template for the exact clinical context/CRT combination for each specific medical payer.

Item 18 The “Synchronizer module For Electronic Medical Record (EMR) System” communicates with the EMR system of subscribing physicians and medical providers. This module updates the subscriber's EMR whenever there is a change in the template stimulated by a change in any of the criteria or conditions.

Item 19 The “Synchronizer module for the Laboratory Information System (LIS)” communicates with the LIS of subscribing entities providing laboratory support services for involved physicians and medical providers. This module updates the subscriber's radiology information system (RIS) whenever there is a change in the template stimulated by a change in any of the criteria or conditions.

Item 20 The “Registry of Specific Documentation Requirements for Each Payer for Each ICD-10 Code for each Procedure and Treatment.” The registry is a database is maintained on cloud-based secure network computers containing the current templates.

Item 21 The “Synchronization module between payers, medical providers, medical information providers (RIS, EMR, LIS systems)” assures that subscriber members always have the latest versions of the templates. The synchronization module communicates with the providers' database using a number of integration tools (e.g. API, HL7, VPN) in order to synchronize the subscribers' databases with the most current template entries and information about current payer requirements.

Item 22 The “API Interface or Secure interface” is a complex of integration devices and secure internet connections that maintain secure connections with the databases of between payers, medical providers, medical information providers (RIS, EMR, LIS systems) and assure that subscribing members have the most current version of all templates and all payer requirements.

Item 23 Compiled data is provided to interested parties including medical payers, governmental records, of the payers' rejection profile and history of and patterns of denial of services would be available to interested sources including medical information system providers (RIS, LIS, EMR).

Item 24 “End User Medical Provider Reporting Templates” are provided to member subscribers.

Item 25 “Secure Portal Access or Secure Interface (e.g. HL7 or API or VPN)” connects the application data with the medical providers' information database.

Item 26 The “Searchable Cloud based information database for Medical Providers” is accessible using a secure web accessible physician and medical provider portal. This searchable cloud based database for medical providers than can look up specific payer criteria and the complied history of a specific payer's denial rates and patterns and red flag “requirements” for establishing “medical necessity” of each payer.

Item 27 The “Medical Providers' Database” can be any of a number of database types but most commonly would be an EMR, RIS/PACS, or LIS.

FIG. 5: This Illustration demonstrates a typical, real-life scenario of disc herniation of the mid-cervical spine with radiculopathy with Oxford as the medical provider. The surgeon received a rejection letter from the patient's insurance provider, Oxford, denying the planned discectomy and surgical fusion as being “not medically necessary based upon the medical record documentation”.

a. In this case, the Oxford “pre-authorization denial letter” states that surgery was denied because it the planned surgical discectomy and fusion and instrumentation was not medically necessary but did not list the reasons for the denial. The physician challenged the denial process but was not given the specific criteria used to evaluate the pre-authorization request or the specific reasons that the submitted medical information did not meet the criteria for “medical necessity”.

The surgeon turns to the application to plan for an appeal of Oxford's denial of pre-authorization. The surgeon first accesses the data archive for history of archive. The archive of Oxford denial letters indicates that the most common reasons cited by Oxford for denial of this specific ICD-10/CPT combination is the radiology report failing to mention nerve root compression, radiology report failing to report cervical instability, not submitting radiology report of radiographs commenting on the presence or absence of spondylosis, clinical reports failing to mention radiculopathy, clinical reports failing to describe the conservative treatment measures that have been taken; electromyography laboratory results failing to document radiculopathy.

The surgeon accesses the application's database of Oxford criteria and learns that Oxford utilizes the Milliman criteria. The surgeon accesses the application's database and establishes the proper ICD-10 code for his patient is M50.12—“Cervical disc disorder with radiculopathy, mid-cervical region”. The surgeon sees that the improper ICD-10 was submitted to Oxford. The appropriate CPT codes being for the considered procedure are for “Cervical Discectomy and Anterior Surgical Fusion and Instrumentation”: 22220, 22585, 22845, 22851, 63075, 63076. The surgeon recognizes that a typographical error was made in the application. The surgeon reviews the application's listing for his patient clinical condition and sees the ACR “Appropriateness of Care®” category: Clinical Condition: Chronic Neck Pain, Variant 7: Radiographs show spondylosis. Neurologic signs or symptoms present. The recommended procedure is MRI w/o contrast (or CT myelogram where MRI is contraindicated). The ACR APPROPRIATENESS OF CARE® supports an MRI as the most appropriate imaging testing as documentation most appropriate imaging test in this clinical setting. It is very important for physicians to utilize the most “Appropriate” imaging study during the process of application for surgical pre-authorization to the medical payer. The surgeon recognizes that there was no radiology report of radiographs documenting whether there is evidence of spondylosis. The surgeon also determines that the radiology report did not include the requisite statement about the disc herniation compressing the adjacent spinal cord and the nerve root that matches the side and level of the radiculopathy.

The surgeon accesses the Oxford report templates for the M50.12/CPT code combination for radiology reports, clinical report documentation, and laboratory report templates. The surgeon reviews the medical record and determines that the patient's condition meets the required criteria but that the submitted application did not present the information in the proper format and content. The surgeon utilizes the customized templates for radiology, clinical reporting and laboratory reporting to submit the documentation required by Oxford in optimal form and format. The appeal was successful and the surgical pre-authorization was approved.

FIG. 6: Insurance companies have commissioned actuaries and medical accounting firms to create proprietary criteria for establishing “medical necessity” of various medical treatments. One of the more widely used criteria are the Milliman Care Guidelines (MCG, www.careguidleines.com) criteria. This figure includes the Milliman Care Guidelines for “Cervical fusion, anterior with or without Instrumentation” category. The Milliman Care Guidelines in this category include multiple potential clinical scenarios that may apply to the same proposed treatment (i.e. Cervical fusion, anterior with or without Instrumentation) although most do not apply to creation of a report template or a given particular clinical scenario. These are a sample of the Milliman Care Guidelines that were present at the time of the writing of this application. The current art analyzes the criteria from the agency (i.e. Milliman Care Guidelines) and extracts the clinical context that applies to a particular clinical situation. In the figure, the segments of the Milliman Care Guidelines that apply to the clinical setting of a patient with a cervical disc herniation with neural compression are highlighted in Bold.

FIG. 7: This figure lists the ICD-10 codes for “Cervical disc disorder with radiculopathy, mid-cervical region” from the 2013 International Statistical Classification of Diseases and Related Health Problems (ICD) Database and Rules (ICD-10) standard for the Illustration clinical scenario presented as an example. This ICD-10 code represented is M50.12. The current art extracts the information that is pertinent to the clinical scenario being considered and the customized report being created. The extracted information is highlighted in Bold.

FIG. 7: Example of the American College of Radiology Appropriateness of Care® for the Illustration clinical scenario presented. The pertinent information is extracted from the ACR database using the most appropriate data feed existing at the time (e.g. API, HL7, VPN) and the data is utilized to assure that the most appropriate radiology test is acquired in the evaluation process of a particular clinical scenario.

FIG. 9: Sample customized radiology report template for the presented clinical setting of a patient with a “cervical disc herniation with nerve compression”. This customized report was created to include the clinical information and prompts the radiologist to comment on the pertinent finding in the body of the report and the specific criteria of the insurance company's requirements re listed at the bottom of the report template.

FIG. 10: Diagrammatic representation of the hardware infrastructure existing in a private cloud computing network. The network includes proprietary software and collection of computing processes units and databases that exist on multiple physical computers and virtual machines (VM) existing as a component of a larger server computer containing multiple virtual machines (VMs). This figure displays the various processing and analyzing modules.

FIG. 11: Diagrammatic representation of the hardware infrastructure existing in a private cloud computing network. The network includes proprietary software and collection of computing processes units and databases that exist on multiple physical computers and virtual machines (VM) existing as a component of a larger server computer containing multiple virtual machines (VMs). This figure displays the various customized report Assembler and Synchronizer modules.

I claim:

1. The invention as described above.

2. A system, comprising:
Collection of information related to a patient's care;
Encoding of said information related to said patient's care;
Determining optimal radiology imaging study;
Interpreting the guidelines of said patient's insurance company; and
Generating a customized report template.

3. The system of claim 2, further comprising:
Sending said customized report template to said patient's insurance company.

4. The system of claim 2, further comprising:
Applying for surgical preauthorization from a report generated in association with said customized report template.

5. A system, comprising:
Receiving a denial from an insurance company related to an application for surgical preauthorization;
Documenting the criteria for acceptance related to said application for surgical preauthorization;
Generating a customized report template incorporating said criteria for acceptance; and
Utilizing said customized report template to create a revised application for surgical preauthorization.

6. An article of manufacture comprising:
a set of application program interfaces embodied on a computer-readable medium for execution in conjunction with an application program that streamlines the preparation and filing of healthcare insurance claims and establishes medical necessity to increase the likelihood of insurance payment, comprising:
a first Processing and Transfer interface that communicatively processes and sends to a Healthcare Information System or a plurality of Healthcare Information Systems information from one or many medical databases and/or information related to medical insurance to the API processing module;
a second API processing module interface that processes information from a multitude of medical databases and medical insurance-related information based upon data input relating to patient information;
a third Iterative Collator interface that processes the information from the first and second interfaces and displays queries to and receives inputs from the Healthcare Provider to couple Healthcare Provider input information with information stored on a Healthcare Information System or a plurality of Healthcare Information Systems;
a fourth Registry of Specific Documentation Requirements interface that assembles, customized report template or plurality of customized report templates;
a fifth Storage and Retrieval interface that stores and retrieves the assembled customized report template or plurality of customized report templates; and
a sixth Security interface within and between the aforementioned interfaces, and non-application program users and databases.

7. The article of manufacture in claim 6, in which said first Processing and Transfer interface receives information from Medical Payers Databases, Current Procedural Terminology Codes, International Statistical Classification of Diseases and Related Health Problems database and rules, and American College of Radiology Appropriateness of Care Databases.

8. The article of manufacture in claim 7, in which the said first Processing and Transfer interface consists of a sub-interface to receive medical-insurance related rejection explanations.

9. The article of manufacture in claim 6, in which the information stored on a Healthcare Information System or medical-insurance related rejection explanations are received from other Application Programming Interfaces (API) and/or Virtual Private Networks (VPN).

10. The article of manufacture in claim 6, in which said first Processing and Transfer interface is the Application Programming Interface Integrator.

11. The article of manufacture in claim 6, wherein the second second API processing module interface organizes the Healthcare Information Systems information from Medical Payers Databases, Current Procedural Terminology Codes, International Statistical Classification of Diseases and Related Health Problems database and rules, American College of Radiology Appropriateness of Care® Databases and medical-insurance related rejection explanations, in a readable format for other interfaces within and outside the application program.

12. The article of manufacture in claim 6, in which said third Iterative Collator interface undergoes a reiterative process of query display, input, and input processing until an appropriate medical action or necessary medical action is reached.

13. The article of manufacture in claim 12, in which said input constitutes patient information obtained from Healthcare Providers, other Application Programming Interfaces (API), Health Level 7 (HL7) encoded information sources, and Virtual Private Networks (VPN).

14. The article of manufacture in claim 12, in which said third Iterative Collator interface undergoes a reiterative process of query display, input, and input processing using guidelines obtained from a Healthcare Information System or plurality of Healthcare Information Systems, Medical Payers Databases, Current Procedural Terminology Codes, International Statistical Classification of Diseases and Related Health Problems database and rules, American College of Radiology Appropriateness of Care® Databases, medical-insurance related rejection explanations, and Healthcare Provider input information.

15. The article of manufacture in claim 6, in which said third Iterative Collator interface undergoes a reiterative process of query display, input, and input processing using guidelines tailored to Electronic Medical Records System (EMR), Radiology Information System (RIS), or Laboratory Information System (LIS).

16. The article of manufacture in claim 6, in which said fourth Registry of Specific Documentation Requirements interface stores the results or reports of the corresponding medical action from the third interface on a cloud-based computer-readable medium.

17. The article of manufacture in claim 6, in which said fifth Storage and Retrieval interface further displays the corresponding medical action from the third interface to the healthcare provider in the form of a customized report template.

18. The article of manufacture in claim 17, in which the customized report template is accessible by the Healthcare Provider by search, access and retrieval from a cloud-based information database through a user interface.

19. The article of manufacture in claim 6, in which the sixth Security interface consists of an input query to allow only Healthcare Providers, regulators of said database, and insurance providers to access, as to preserve patient confidentiality.

20. The method in claim 6 for creation of radiology and clinical evaluation reporting templates using ICD-10, CPT Codes, ACR Appropriateness Criteria® Data, and Insurance Payer and patient information, in which Healthcare Providers can interact with the user interface on said application program to create insurance securely and easily.

21. An article of manufacture comprising:
a set of application program interfaces embodied on a computer-readable medium for execution in conjunction with an application program that streamlines the preparation and filing of healthcare insurance claims and establishes medical necessity to increase the likelihood of insurance payment, comprising:
a first Processing and Transfer interface that processes and sends information to Healthcare Information Systems from a multitude of medical databases and information related to medical insurance to the API processing module;
a second API processing module interface that processes information from a multitude of medical databases and medical insurance-related information based upon data input relating to patient information;
a third Analyzer interface that processes the information from the first and second interfaces based on the type of information retrieved from a Healthcare Information System and displays, queries to and receives inputs from the Healthcare Provider to couple Healthcare Provider input information and information retrieved from a Healthcare Information System or a plurality of Healthcare Information Systems;
a fourth Registry of Specific Documentation Requirements interface that assembles, customized report templates from the processes of the aforementioned interfaces;
a fifth Storage and Retrieval interface that stores and retrieves the assembled customized report templates accessed by the Healthcare Provider;
a sixth Security interface within and between the aforementioned interfaces, and non-application program users and databases.

22. The article of manufacture in claim 21, in which said first Processing and Transfer interface receives information stored on a Healthcare Information System or plurality of Healthcare Information Systems from Medical Payers Databases, Current Procedural Terminology Codes, International Statistical Classification of Diseases and Related Health Problems database and rules, and American College of Radiology Appropriateness of Care® Databases.

23. The article of manufacture in claim 21, in which the said second API processing module interface consists of a sub-interface to receive medical-insurance related rejection explanations.

24. The article of manufacture in claim 23, in which said information or medical-insurance related rejection explanations are received from other Application Programming Interfaces (API), Health Level 7 (HL7) encoded information sources, and Virtual Private Networks (VPN).

25. The article of manufacture in claim 21, in which said first interface is the Application Programming Interface Integrator.

26. The article of manufacture in claim 21, wherein the second API processing module interface aggregates information from Medical Payers Databases, Current Procedural Terminology Codes, International Statistical Classification of Diseases and Related Health Problems database and rules, American College of Radiology Appropriateness of Care® Databases and medical-insurance related rejection explanations into individual processing modules and sends said information to a Healthcare Information System or a plurality of Healthcare Information Systems.

27. The article of manufacture in claim 21, in which said third Analyzer interface undergoes a reiterative process of query display, input, and input processing based on ACR AOC, ICD-10 code, or Oxford Utilizes Milliman Criteria until guidelines for an appropriate medical action or necessary medical action are met.

28. The article of manufacture in claim 21, in which said input constitutes patient information collected from Healthcare Providers, other Application Programming Interfaces (API), Health Level 7 (HL7), and Virtual Private Networks (VPN).

29. The article of manufacture in claim 21, in which said third Analyzer interface undergoes a reiterative process of query display, input, and input processing using guidelines set forth by the information collected from Medical Payers Databases, Current Procedural Terminology Codes, International Statistical Classification of Diseases and Related Health Problems database and rules, American College of Radiology Appropriateness of Care® Databases, medical-insurance related rejection explanations, and Healthcare Provider input information.

30. The article of manufacture in claim 21, in which said third Analyzer interface undergoes a reiterative process of query display, input, and input processing using guidelines designated for use with an Electronic Medical Records System (EMR), Radiology Information System (RIS), or Laboratory Information System (LIS).

31. The article of manufacture in claim 21, in which said fourth Registry of Specific Documentation Requirements interface stores the results or reports of a medical action from the third Analyzer interface on a cloud-based computer-readable medium.

32. The article of manufacture in claim 21, in which said fifth Storage and Retrieval interface further displays the corresponding medical action from the third Analyzer interface to the healthcare provider in the form of a customized report template.

33. The article of manufacture in claim 21, in which the customized report template is accessible by the Healthcare Provider by search, access and retrieval from a cloud-based information database through a user interface.

34. The article of manufacture in claim 21, in which the sixth Security interface consists of an input query to allow only Healthcare Providers, regulators of said database, and insurance providers to access, as to preserve patient confidentiality.

35. The method in claim 21 for creation of radiology and clinical evaluation reporting templates using ICD-10, CPT Codes, ACR Appropriateness Criteria® Data, and Insurance Payer and patient information, in which Healthcare Providers can interact with the user interface on said application program to create insurance securely and easily.

36. A computer-readable medium having computer-executable instructions for performing a method comprising:
generating templates for an insurance appeals process;
providing healthcare providers with explanations for rejections given by an insurance company;
developing responses to rejections given by said insurance company to meet said insurance company's criteria for authorization;
creating pre-authorization application documentation.

37. The invention in claim 36, in which access to said method is available to subscribers on a fee subscription basis.

38. The invention in claim 36, in which said subscribers comprise Hospitals or Healthcare Providers.

39. The invention in claim 36, wherein healthcare providers access said explanations for rejections through a user interface connected to a cloud-based database.

40. The cloud-based database in claim 37, further comprising a computer system connected to a storage device or a plurality of storage devices accessed through a network.

41. The invention in claim 36, wherein said interface comprises a graphical user interface that includes a search function.

42. The invention in claim 41, wherein said search function enables a user to input search terms to discover information related to insurance company rejections, said information related to insurance company rejections stored on a connected cloud-based database.

43. The invention in claim 36, wherein said templates are processed and generated using information retrieved directly from Healthcare Providers or Healthcare Information System databases.

44. The invention in claim 36, wherein said information retrieved directly from Healthcare Providers is transferred by said Healthcare Providers via a graphical user interface.

45. The invention in claim 36, wherein said information is retrieved from an Electronic Medical Records System, Radiology Information System, Laboratory Information System or databases connected to said systems.

46. The invention in claim 45, wherein said information is further retrieved automatically.

47. The invention in claim 36, wherein said templates are generated by incorporating information retrieved from an entry of patient testing and diagnosis information, correspondence related to insurance rejections, guidelines obtained from a Healthcare Information System or plurality of Healthcare Information Systems, a payor database or plurality of payor databases, Current Procedural Terminology Codes, International Statistical Classification of Diseases and Related Health Problems database and rules, and/or American College of Radiology Appropriateness of Care Databases.

48. A method of providing and selecting from a menu in a graphical user interface, the method comprising:
accessing a cloud-based database;
retrieving from said cloud-based database a set of menu entries for the menu, each of the menu entries representing an insurance company, a diagnosis characteristic, a procedure characteristic and/or information related to an insurance company rejection;
displaying the set of menu entries within said graphical user interface;
receiving a menu entry selection signal indicative of the selection device pointing at a selected menu entry from the set of menu entries;
in response to the signal, performing a search of said cloud-based database for a match to the insurance company, diagnosis characteristic, procedure characteristic and/or information related to an insurance company rejection; and
displaying said search result or plurality of search results.
